(19) United States
(12) Patent Application Publication
(10) Pub. No.: US 2010/0049404 A1
(43) Pub. Date: Feb. 25, 2010

(54) Driver's Cab of a Commercial Vehicle Having Cab Components Which are Integrated into the Loadbearing Structure

(76) Inventors: Gerhard Rieck, Muenchen (DE); Michael Herges, Muenchen (DE); Juergen Stocker, Stuttgart (DE); Gary Jones, Asperg (DE); Denis Battistella, Paderno Dugnano (IT)

Correspondence Address: CROWELL & MORING LLP;INTELLECTUAL PROPERTY GROUP, P.O. BOX 14300, WASHINGTON, DC, 20044-4300, US

(21) Appl. No.: 12/296,243

(22) PCT Filed: Apr. 4, 2007
(86) PCT No.: PCT/EP2007/003038

§ 371 Date: Jun. 1, 2009

(30) Foreign Application Priority Data
Apr. 4, 2006 (DE) 10 2006 015 650.1

(51) Int. Cl. B62D 33/06; B60R 21/01; B62D 1/16

(52) U.S. Cl. 701/45; 701/1

(57) ABSTRACT

A driver's cab of a commercial vehicle includes a steering column which has a steering spindle mounted rotatably in a steering column tube, and at least one pedal carrier, on which at least one driving pedal is mounted. At least the steering column tube of the steering column and the pedal carrier form parts of the load-bearing structure of the driver's cab.

### BACKGROUND AND SUMMARY OF THE INVENTION

The invention relates to a driver's cab of a commercial vehicle including a steering column having a steering spindle mounted rotatably in a steering column tube, and at least one pedal carrier on which at least one driving pedal is mounted.

The prior art discloses drivers' cabs in which the steering column tube of the steering column and the pedal carrier constitute separate constructional units, which are secured to the load-bearing structure of the driver's cab.

According to WO 00/71407 A1, the driver's cab includes a steering column, which includes a steering spindle mounted rotatably in a steering column tube, and at least one pedal carrier on which at least one driving pedal is mounted, wherein at least the steering column tube of the steering spindle and the pedal carrier are combined to form a common constructional unit forming part of the load-bearing structure of the driver's cab.

According to U.S. Pat. No. 4,597,461 A1, a pre-manufactured module for the cockpit region of a vehicle is proposed. The module is supported by a front splash wall which delimits the engine compartment. US 2005/028 discloses a module which combines a steering column and a set of pedals for a vehicle.

By contrast, the present invention is based on the object of further developing a driver's cab of the type mentioned above in such a manner that, by integrating further components, the installation is simplified and the functional reliability is increased.

This object is achieved according to the invention by a driver's cab of a commercial vehicle, including a steering column, having a steering spindle mounted rotatably in a steering column tube, and at least one pedal carrier on which at least oen driving ipedal is mounted. At least the steering column tube of the steering column and the pedal carrier are combined to form a common constructional unit, which forms part of the load-bearing structure of the driver's cab. In addition, at least the following components or assemblies are combined with the constructional unit to form a separate, pre-manufaturable module: a) at least one sensor for recording movements of the steering spindle and/or at least oen driving pedal; b) at least one electronic control device for one or more vehicle functions; c) at least one radiator grill; d) the steering wheel; e) at least one airbag system including at least one acceleration sensor; f) at least one radar sensor of an adaption speed control (ASC); g) at least one headlight and/or at least one signal lamp; h) an engine hood; and i) the at least one driving pedal.

According to the invention, at least the steering column tube of the steering column and the pedal carrier are not, as in the prior art, merely secured to the load-bearing structure, but rather form parts of the load-bearing structure of the driver's cab itself. Since these components are incorporated into the load-bearing structure of the driver's cab, they advantageously contribute to increasing the rigidity thereof As a result, for example by saving on material, such as by having fewer frame parts, stiffening ribs or beads, the load-bearing structure can weigh less and can also have a more flexible design. Not least, the combining of the functions in the form of support components at least for the steering spindle and the driving pedals and, at the same time, in the form of a structural component contributes to saving costs.

Furthermore, the steering column tube of the steering column and the pedal carrier are combined to form a common constructional unit, which is part of the load-bearing structure of the driver's cab. This combining in a structural unit can take place, for example, by a single-piece design of the steering column tube of the steering column and of the pedal carrier, or by flanging the individual components or assemblies to one another.

According to the invention, in addition at least the following components or assemblies are combined with the constructional unit to form a module which can be premanufactured separately:
a) at least one electronic control device for one or more vehicle functions,
b) at least one radiator grill fastened to the front wall,
c) the steering wheel,
d) at least one airbag system including at least one acceleration sensor,
e) at least one radar sensor of an adaption speed control (ASC),
f) at least one headlight held on the front wall and/or at least one signal lamp,
g) an engine hood mounted on the front wall,
h) a driving pedal, such as a brake, gas or clutch pedal,
i) at least one sensor for recording movements of the steering spindle and/or of the driving pedals.

This measure makes it easier to manufacture the driver's cab, since the separate module permits simpler installation of the above-mentioned components and assemblies than is the case in a driver's cab which is already fitted on the commercial vehicle. This likewise contributes to a reduction in manufacturing costs.

Since the movements of the pedals and/or of the steering spindle are generally detected by electric rotational angle or displacement sensors, and the sensed signals are converted by electronic control devices within the scope of a control structure into actuating signals for corresponding actuators, the integration of such control devices into the module affords the advantage of shorter cabling, which can be laid with little effort and is less susceptible to faults. Furthermore, the driver's cab of a commercial vehicle is generally designed in a manner such that it can be tilted in relation to the frame, and therefore a connecting cable, for example in the form of a CAN data bus to a control device arranged outside the driver's cab, would be exposed to a certain degree of mechanical stress.

Not least, the elements of the control structures assigned to the vehicle functions, such as the sensor arrangement, the control device, the cabling and, under some circumstances, also the actuators can be integrated into the module because, as a result, the configuration and test sequences are possible before the module is installed on the commercial vehicle and therefore the fail safety is increased.

Advantageous developments and improvements of the invention are described herein.

According to one development, the load-bearing structure and the constructional unit including the steering column tube of the steering column and the pedal carrier can be designed such that both right-hand-drive and left-hand-drive commercial vehicles can be realized. This reduces the multiplicity of variants and contributes to saving costs.

To further increase the rigidity of the driver's cab, a single-part or multi-part dashboard can likewise be part of the load-bearing structure, thus resulting in the advantages already described above. According to a development of these measures, the dashboard can be at least partially part of a deformation zone of the driver's cab, as a result of which it carries out a dual function which likewise saves weight. Not least, a further structure is present as a result in order to influence the deformation behavior of the driver's cab.

In this case, any desired control devices controlling vehicle functions can be integrated into the module, in particular a central vehicle control device, a brake control device of an electronic brake system (EBS), a control device of an electronic stability program (ESP), or an airbag control device.

More precise details are revealed in the description below of an exemplary embodiment.

### BRIEF DESCRIPTION OF THE DRAWINGS

An exemplary embodiment of the invention is illustrated below in the drawing and is explained in more detail in the description below. In the drawing:

FIG. 1 is a highly schematic rear view of a front wall of a driver's cab of a commercial vehicle, in which the invention according to a preferred embodiment is implemented; and

FIG. 2 is a cutout from FIG. 1 in the form of a constructional unit, including the steering column tube of the steering column and the pedal carrier.

### DETAILED DESCRIPTION OF THE DRAWINGS

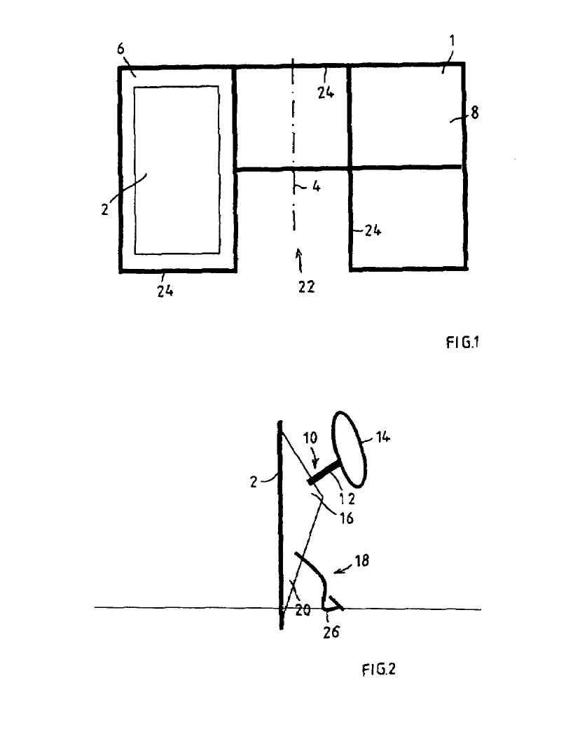

FIG. 1 shows schematically a rear view of a front wall 1 of driver's cab of a commercial vehicle, i.e. the viewing direction is directed from the interior of the driver's cab to the front wall 1. Halves 6, 8 which are substantially symmetrical with respect to a central vertical axis 4 can be seen. A steering column 10 having a steering column tube 16, which supports a steering spindle 12 for a steering wheel 14, and a pedal module 18 fastened to a pedal support 20 and having driving pedals 26, such as, for example, a gas pedal, a brake pedal, and a clutch pedal, and also a sensor arrangement for recording the pedal movement, are arranged in the left half 6, for a standard embodiment, but are only illustrated in FIG. 2 rather than in FIG. 1 for graphical reasons.

In this case, the mounting for the driving pedals 26 on the pedal module 18 is designed such that the pedal carrier 20 merely includes a bearing plate or receptacle for the pedal module 18. However, according to an alternative, the driving pedals 26 could also be accommodated directly on the pedal carrier 20, which then also has to accommodate the displacement or angle sensor arrangement in addition to the pedal bearings.

At least the steering column tube 16 of the steering column 10 and the pedal support 20, here, form parts of the load-bearing structure of the driver's cab, which structure includes, inter alia, the front wall 1 and frame parts 24 connected thereto. Furthermore, the load-bearing structure of the driver's cab is intended to be understood to mean all those structural components, such as, for example, frame, windows, front, side and rear walls, the roof, the floor, and also all stiffening means which make a contribution to obtaining the desired strength and (flexural, torsional) rigidity of the driver's cab and which are sensed by the force flux caused by dead weight or external forces.

In this case, at least the steering column tube 16 of the steering column 10 and the pedal carrier 20 are, particularly preferably, combined to form a common constructional unit 2 which is part of the load-bearing structure 1, 24 of the driver's cab and is connected thereto with a cohesive material joint or in a frictional or interlocking manner. This combining in a structural unit 2 can take place, for example as shown in FIG. 2, by way of a single-piece design of the steering column tube 16 of the steering column 10 and of the pedal carrier 20, or by flanging the individual components or assemblies 16, 20 to one another.

The front wall 1 of the driver's cab 2 and the constructional unit 2 including steering column tube 16 and pedal carrier 20 can be designed such that both right-hand-drive and left-hand-drive commercial vehicles can be realized without the front-wall 1 or the constructional unit 2 having to be changed. For this purpose, identical receptacles, connections or cutouts for the constructional unit 2, at which the latter can be received and to which it can be connected with a cohesive material joint or in an interlocking-or frictional manner, can be provided, for example in the left half 6 and in the right half 8 of the front wall 1. In this case, the receptacles, connections, or cutouts are designed in such a manner that at least part of the force flux present in the region thereof is conducted through or along the constructional unit 2. In this manner, the constructional unit 2 is integrated into the load-bearing structure of the driver's cab, here into the front wall 1 and into the frame parts 24 thereof.

To further increase the rigidity of the driver's cab 2, a single-part or multi-part dashboard (not shown in the figures), which is fastened to the front wall 1 can likewise be part of the load-bearing structure 1, 24. According to a development of these measures, the dashboard can be at least partially part of a deformation zone of the driver's cab 2.

Particularly preferably, at least the following components or assemblies (not shown in the figures) can be combined with at least the front wall 1 of the driver's cab, with the constructional unit 2 including the steering column tube 16 and the pedal carrier 20, and, if appropriate, with the dashboard as supporting structure to form a module 22, which can be premanufactured separately:
a) at least one electronic control device for one or more vehicle functions,
b) at least one radiator grill fastened to the front wall 1,
c) the steering wheel 14,
d) at least one airbag sensor, which is held on the steering wheel 14, including at least one acceleration sensor,
e) at least one radar sensor of an adaptive speed control (ASC),
f) at least one headlight held on the front wall 1 and/or at least one signal lamp,
g) an engine hood mounted on the front wall 1,
h) a driving pedal 26, such as a brake pedal, gas pedal or clutch pedal, and
i) at least one sensor for recording movements of the steering spindle 12 and/or of the driving pedals 26.

According to one development, further parts of the load-bearing structure of the driver's cab, such as, for example, side walls, floor, roof and frame parts, can be integrated into the module 22 and into further assemblies related to vehicle functions.

Not least, any desired control units which control vehicle functions can be integrated into the module 22, in particular a central vehicle control device, a brake control device of an electronic brake system (EBS), a control device of an electronic stability program (ESP) or an airbag control device.

### TABLE OF REFERENCE NUMERALS

1 Front wall

2 Constructional unit

4 Vertical axis

6 Left

8 Right

10 Steering column

12 Steering spindle

14 Steering wheel

16 Steering column tube

18 Pedal device

20 Pedal carrier

22 Module

24 Frame parts

16 Driving pedal

1.-8. (canceled)

9. A cab of a commercial vehicle, comprising:
a steering column including a steering spindle mounted rotatably in a steering column tube;
at least one pedal carrier having at least one driving pedal mounted thereon;
wherein at least the steering column tube and the pedal carrier are combined into a common constructional unit forming a part of a load-bearing structure of the cab; and
wherein a pre-manufacturable separate module includes the common constructional unit combined with:
a) a sensor for recording movement of the steering spindle and/or the driving pedal;
b) an electronic control device for controlling one or more vehicle functions;
c) a radiator grill;
d) a steering wheel;
e) an airbag system including an acceleration sensor;
f) a radar sensor of an adaptive speed control system;
g) a lamp of the commercial vehicle;
h) an engine hood; and
i) the at least one driving pedal.

10. The cab according to claim 9, wherein at least one part of the load-bearing structure and the common constructional unit is operatively configured such that right-hand-drive and left-hand-drive commercial vehicles are both manufacturable.

11. The cab according to claim 9, wherein a dashboard is a part of the load-bearing structure of the cab.

12. The cab according to claim 11, wherein the dashboard is of a single-part or multi-part design and at least partially part of a deformation zone of the cab.

13. The cab according to claim 9, wherein the electronic control device is at least one of: a central vehicle control device, a brake control device of an electronic braking system, an airbag control device, an electronic stability program control device, and an adaptive speed control device.

14. The cab according to claim 9, wherein the part of the load-bearing structure integrated in the pre-manufacturable module comprises at least one front wall of the cab.
